(19) United States
(12) Patent Application Publication
(10) Pub. No.: US 2008/0129032 A1
(43) Pub. Date: Jun. 5, 2008

(54) METHODS FOR PRODUCING A PUBLICATION HAVING A SUBSTANTIALLY TWO DIMENSIONAL IMAGE ON A SURFACE HAVING A TOPOGRAPHICAL TEXTURE, AND A PUBLICATION BEARING SUCH AN IMAGE

(75) Inventors: Wayne Ernest Conrad, Hampton (CA); Nina Kanevsky Conrad, Hampton (CA); Helmut Horst G. Conrad, Hampton (CA); Ron Hills, Hampton (CA)

Correspondence Address: BERESKIN AND PARR, 40 KING STREET WEST, BOX 401, TORONTO, ON, M5H 3Y2, omitted

(73) Assignee: 2089275 ONTARIO LTD., Richmond Hill (CA)

(21) Appl. No.: 11/774,717

(22) Filed: Jul. 9, 2007

Related U.S. Application Data
(63) Continuation-in-part of application No. 11/571,317.
Application No. 11/571,317 is a continuation-in-part of application No. 11/571,300.
Application No. 11/571,300 is a continuation-in-part of application No. 11/571,323.
(60) Provisional application No. 60/610,170, filed on Sep. 16, 2004.
(60) Provisional application No. 60/621,669, filed on Oct. 26, 2004.
(60) Provisional application No. 60/624,547, filed on Nov. 4, 2004.
(60) Provisional application No. 60/654,936, filed on Feb. 23, 2005.
(60) Provisional application No. 60/654,941, filed on Feb. 23, 2005.
(60) Provisional application No. 60/654,938, filed on Feb. 23, 2005.
(60) Provisional application No. 60/654,937, filed on Feb. 23, 2005.

(51) Int. Cl. B42D 15/00; B42C 19/00; B42D 3/00

(52) U.S. Cl. 281/29; 412/6; 412/4; 281/38

(57) ABSTRACT

A plastic or metal substrate is included in a publication.

### RELATED APPLICATIONS

This application is a (1) continuation-in-part of U.S. Utility patent application Ser. No. 11/571,317 filed on Dec. 27, 2006, which is a national phase application of International Application No. PCT/CA2005/001415 filed Sep. 16, 2005, which claims the benefit of U.S. Provisional Patent Application No. 60/610,170 filed on Sep. 16, 2004, and (2) a continuation-in-part of U.S. Utility patent application Ser. No. 11/571,300 filed on Dec. 27, 2006, which is a national phase application of International Application No. PCT/CA2005/001578 filed on Oct. 18, 2005, and (3) a continuation-in-part of U.S. Utility patent application Ser. No. 11/571,323 filed on Dec. 27, 2006, which is a national phase application of International Application No. PCT/CA2005/001579 filed Oct. 18, 2005, which claims the benefit of U.S. Provisional Patent Application Nos. 60/621,669 filed on Oct. 26, 2004; 60/624,547 filed on Nov. 4, 2004; 60/654,936 filed on Feb. 23, 2005; 60/654,941 filed on Feb. 23, 2005; 60/654,938 filed on Feb. 23, 2005; and 60/654,937 filed on Feb. 23, 2005 the entire contents of all of which are hereby incorporated by reference.

### FIELD OF THE INVENTION

This invention relates to methods for using a deformable non-cellulose substrate, such as a substrate made of metal or plastic. In a case of a plastic substrate, the plastic may be polystyrene or polyvinylchloride (PVC).

### BACKGROUND OF THE INVENTION

It is known to produce art reproductions by printing an image on a thermoformable sheet and subsequently subjecting the thermoformable sheet to vacuum molding to provide topography in the image surface thereof. See for example U.S. Pat. Nos. 5,958,470 and 5,904,962. In addition, other limited uses of artwork reproduced on a thermoformable sheet have been proposed in U.S. Pat. No. 5,904,962.

### SUMMARY OF THE INVENTION

In accordance with the instant invention, improved methods and products are provided for utilizing non-cellulose deformable substrates. The substrate has a two-dimensional image. For example, an image may be provided on the front or image bearing face of the substrate, such as by being printed thereon. The substrate is treated, such as by being subjected to pressure and/or vacuum forming, to create a three-dimensional representation or topography corresponding to, e.g., an original piece of art, a design, an advertisement or any other desired image.

In accordance with an embodiment of the instant invention, a substrate may be included as a page in a publication. For example, a thermoformable plastic sheet may be printed and incorporated in a publication, such as a book or magazine. Preferably, the substrate is the cover of the publication with the image and topography on the outer surface of the cover of the publication when the publication is closed and facing up.

The publication may be bound by any means known in the art publication arts, such as spot gluing, heat staking, stapling, sewing or otherwise mechanically affixing the pages together. If a staple or other mechanical member such as a post or ring is inserted through the substrate, then the passage of the staple through the substrate may provide a point of stress, which may result in a crack being formed that extends through the image-bearing portion of the substrate. Accordingly, if a substrate is to be incorporated as a page, including a cover page, of a publication by a member passing through the publication including the substrate to bind the substrate as a page in the publication, then the substrate is preferably configured to receive the staple or other member that may pierce the substrate without the substrate being deformed or pierced by the staple or other member. Preferably to substrate is so configured by providing holes at a location where the staple or other binding will pass through the substrate. Alternately, or in addition, the substrate may be thickened at the portion where the hole is provided.

Alternately or in addition, a thermoformable sheet may be incorporated into a publication by associating the thermoformable sheet, which has an image and a three dimensional profile produced therein, with paper or other sheets known in the art which are used in preparing publications (a mounting substrate). Accordingly, the mounting substrate is used to secure the image substrate in a publication. For example, in one particularly preferred embodiment, the image substrate may be an advertisement for a product. The mounting substrate may be a sheet of paper or the like and the publication is a magazine. Accordingly, in accordance with this invention, it is possible to mass produce magazines which have advertisements provided therein which are printed on thermoformable plastic and have a relief or topography provided in the thermoformable sheet (i.e. a three dimensional image). By using a mounting substrate, it is possible to incorporate three-dimensional advertisements or the like into publications using existing binding techniques.

Preferably, the image substrate is attached to the mounting substrate prior to the mounting substrate being incorporated into the publication. However, it will be appreciated that in an alternate embodiment, the image substrate may be affixed to the mounting substrate subsequent to the mounting substrate being incorporated into the publication.

In such an embodiment, the image substrate and the mounting substrate are a composite work that together form a “page” in the publication. A further advantage of this aspect of the instant invention is that, by using a mounting substrate, both sides of the page may be utilized to contain articles, images or any other material routinely incorporated into a publication. For example, the image-bearing surface of the image substrate may have a picture, advertisement or the like provided therein. The opposite or rear surface of the image substrate contains the negative version of the topography provided in the image substrate and is accordingly less desirable for use. For example, it is less desirable to have text on the negative image side of an image substrate as the text may be difficult to read as the surface has the negative topography of the front, image, bearing surface. The side of the mounting substrate that is not affixed to the image substrate may have text, pictures or the like provided thereon. Accordingly, both sides of a “page” are utilized.

The image substrate may be removably affixed to the mounting substrate, such as by a releasable adhesive, which adhesives are known in the art. Alternately, or in addition, the mounting substrate and the image substrate together may be removably affixed to the publication. For example, the mounting substrate may have perforations or a score line provided therein so as to permit the mounting substrate, which has the image substrate provided thereon, to be removed or torn out of a magazine. This particular embodiment may be utilized if the image substrate contains a coupon, poster or the like.

In accordance with the instant invention, there is provided a method of producing a publication comprising
a) providing a plurality of pages;
b) providing a substantially two dimensional image on at least one side of a page of the plurality of pages to provide at least one image page wherein the at least one image page is made of metal or plastic;
c) providing a topographical texture corresponding to at least one feature of the two dimensional image, such that the at least one feature of the two dimensional image varies in a third dimension orthogonal to the two dimensions of the two dimensional image; and,
d) attaching the plurality of pages together to form the publication.

In one embodiment, the at least one page is made of a deformable material, and step (c) comprises molding the deformable material to provide the topographical texture.

In another embodiment, the at least one image page is made of plastic.

In another embodiment, the at least one image page is molded to provide the topographical texture.

In another embodiment, the method further comprises attaching the at least one image page as the cover of the publication.

In another embodiment, the at least one image page comprises an image side bearing the two dimensional image and a reverse side and the method further comprising providing a backing layer on the reverse side.

In another embodiment, the backing layer is formed by adhering an additional page to the reverse side.

In another embodiment, the at least one image page comprises an image side bearing the two dimensional image and a reverse side and the method further comprising providing a backing layer on the reverse side.

In another embodiment, the backing layer is formed by adhering an additional page to the reverse side.

In accordance with another aspect of this invention, there is also provided a publication comprising a plurality of pages, including at least one image page, non-replacably secured together, the at least one image page being made of at least one of metal and plastic and having a textured image comprising:
a) a substantially two dimensional image on at least one side of the image page; and,
b) a texture aligned with the two dimensional image wherein the texture corresponds to at least one feature of the two dimensional image.

In one embodiment, the at least one image page is a molded page.

In another embodiment, the image page is the cover of the publication.

In another embodiment, the image page comprises an image side bearing the two dimensional image and a reverse side and the reverse side has a backing layer affixed thereto.

In another embodiment, the backing layer comprises an additional page affixed to the reverse side.

In another embodiment, the additional page has a print side and a reverse side and the reverse side of the additional page is affixed to the reverse side of the image page and the print side has at least one of an image and a word provided thereon.

In another embodiment, the image page comprises an image side bearing the two dimensional image and a reverse side and the reverse side has a backing layer affixed thereto.

In another embodiment, the backing layer comprises an additional page affixed to the reverse side.

In another embodiment, the additional page has a print side and a reverse side and the reverse side of the additional page is affixed to the reverse side of the image page and the print side has at least one of an image and a word provided thereon.

### BRIEF DESCRIPTION OF THE DRAWINGS

These and other advantages of the instant invention will be more fully and completely understood in association with the following description of the preferred embodiments of the invention in which:

FIG. 1 is a perspective view of a publication which is open to display a page comprising a composite work;

FIG. 2 is a cross-section along the line 2-2 in FIG. 1;

FIG. 3 is an exploded view of a composite work according to an embodiment of the instant invention.

FIG. 3A is a side view of the exploded view of the composite work of FIG. 3;

FIG. 4 is an exploded view of an alternate composite work according to an alternate embodiment of the instant invention;

FIG. 4A is a side view of the exploded composite work of FIG. 4;

FIGS. 5 and 5A show a method of assembling a composite work according to another embodiment of the instant invention;

FIGS. 6 and 6A show a method of assembling a cover page for a book using a composite work according to an embodiment of the instant invention;

FIG. 7 is a perspective view of a publication in accordance with another aspect of this invention wherein the publication has four pages composed of a printed, thermoformed substrate;

FIG. 8 is an end view of the publication of FIG. 7;

FIG. 9 is an enlargement of area A shown in FIG. 8;

FIG. 10 is a perspective view of the publication of FIG. 7 opened to one of the pages having the printed substrate;

FIG. 11 is a top plan view of FIG. 10;

FIG. 12 is an enlarged view of area A of FIG. 11;

FIG. 13 is a cross section along the line 26-26 shown in FIG. 11;

FIG. 14A is a top plan view, and FIG. 14B is a cross sectional view of a cover page of a publication in accordance with an aspect of an embodiment of the present invention; and

FIG. 14C is a top plan view, and FIG. 14D is a cross sectional view, of a publication incorporating the cover page of FIGS. 14A and 14B.

### DETAILED DESCRIPTION OF THE INVENTION

In accordance with this invention, a non-cellulose deformable substrate is used that has a two dimensional image and a three dimensional topography.

The substrate is preferably a plastic or metal and, more preferably, a thermoformable plastic. The thermoformable plastic is preferably one or more of poly vinyl chloride (PVC), ethylene vinyl acetate (EVA), polystyrene, neoprene, polyethylene, ABS, PET, and, more preferably, is EVA, PVC or polystyrene and, most preferably, is polystyrene. The metal is preferably aluminium or brass. One advantage of the use of neoprene is that neoprene may be reversibly deformable and, accordingly, can be reused in the process. If the substrate is an irreversibly deformable thermoplastic such as polystyrene, then the thermoformable plastic may be recycled by grinding the used substrate as is known in the art.

The plastic substrate may have a thickness from 0.002-0.100 inches, preferably from 0.003-0.025 inches, more preferably from 0.006-0.012 inches. The metal substrate may have a thickness from 0.002 to 0.060 inches, preferably 0.003 to 0.020 inches and most preferably 0.005 to 0.012 inches.

The portion of the substrate on which the image is provided, the image bearing portion, may be part or all of the substrate. The image may be a two-dimensional printed image (e.g., it may be an image which is printed by lithography or any other printing or image reproduction means known in the publishing and printing arts). The substrate is treated or formed, preferably after the two dimensional image is printed on the substrate, to have a three-dimensional image or texture provided therein. This results in the production of a relief pattern or topography corresponding to part or all of the printed image thereby resulting in a three-dimensional image. The texturing of the substrate may be prepared by pressure forming, vacuum forming, pressure and vacuum forming, embossing, or applying a variable mechanical force to the substrate so as to produce a plurality of depths in the Z dimension. The variable mechanical force may be produced by a printing head, such as a dot matrix printing head, a daisy wheel printing head, by a plurality of pins or an eclectic deformable LCD whereby a computer signal will result in a physical member contacting and depressing the substrate at different locations. Preferably, the substrate is prepared by pressure and/or vacuum forming. It will be appreciated that the actual method by which the image and the topography are formed in the substrate does not comprise part of this invention and any such method known in the art may be utilized.

The image bearing surface 20 of the substrate has an image provided therein. The image may be a two dimensional image, which may be prepared by printing an image on a thin plastic sheet. The topography may be prepared by preparing a mold that contains a female version of a three dimensional topography corresponding to the image and subjecting the substrate to vacuum and/or a pressure molding to form a male version of the topography in the substrate aligned with the two dimensional printed image. Preferably, image bearing surface 20 is prepared by printing a two dimensional image on image bearing surface 20 and then forming a three dimensional image (a relief pattern) matching the image printed on image bearing surface 20.

Prior to the substrate being subjected to any of the forgoing processes, the rigidity of the substrate may be temporarily reduced such as by increasing the temperature of the substrate or the addition of a chemical additive whose effect or presence is transient. For example, polystyrene, poly vinyl chloride or ABS may be exposed to methyl ethyl ketone (MEK). The MEK results in the thermo-formable plastic temporarily softening thereby enhancing the molding operation.

Such processes and substrates are described in co-pending United States patent application no. U.S. Utility patent application Ser. No. 11/571,323 and U.S. patent application Ser. No. 11/571,300, the disclosures of which are incorporated herein by reference.

It will also be appreciated that the image provided on the substrate need not be an artwork but may be of any design. For example, the image may be a design, photograph, machine produced art or reproduction for an advertisement, a movie poster, packaging for a product and/or gift (e.g., a container), a label, a compact disc cover and/or sleeve, a photographic likeness with three dimensional relief to more closely simulate real life, or point of sale fixtures or portions thereof. Embodiments where a page of a publication is made from a formed substrate will be explained in more detail further on.

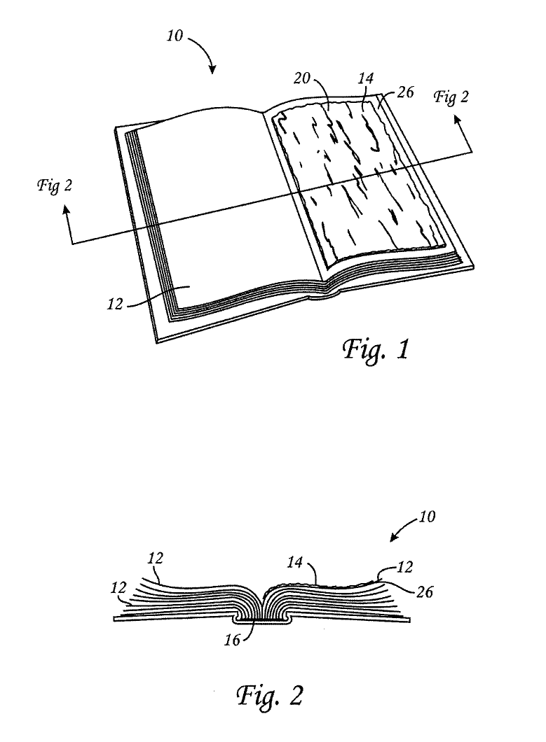

In accordance with one aspect of the instant invention, as exemplified in FIGS. 1 and 2, a publication 10 has a plurality of pages 12. At least one of the pages 12 consists of or includes a non-cellulose substrate with a three dimensional relief pattern corresponding to a two dimensional image. In one embodiment, at least one of the pages 12 comprises a composite work 14. Alternately, the substrate may be directly bound into the publication.

Publication 10 may be any publication that contains a plurality of pages. For example, publication 10 may be a book (which may be a hard cover or a soft cover book). In addition, publication 10 could be a magazine, journal, an art book, a calendar, a brochure, an advertising flyer or insert to a magazine or other publication, an instruction manual, a scroll, a selected portion of a book such as a cover or an interior cover, or the packaging used to transport or distribute other products or the like. Examples of such publications include business journals, medical journals, annual company reports, works of fiction and non-fiction, art books, instruction manuals, calendars, and the packaging used to transport or distribute other products. Publication 10 may have one or more pages made from a non-cellulose based substrate and may have a plurality of pages that are plastic.

It will be appreciated that the type of binding 16 that is utilized may vary depending upon the type of publication. In one embodiment, the binding may utilize a member that penetrates through the pages of the publication. For example, in the case of a magazine, the publication may be secured by staples. Alternately, in the case of a book, the pages may be secured together by stitching or stitching and an adhesive. In accordance with this embodiment, the binding includes an elongate member, such as staples or stitching, which passes through the pages 12. Accordingly, in the case of a magazine, the elongate member may be a staple that extends through all of the pages so as to secure the pages together. Typically, two such staples are provided at spaced apart locations along the spine of a magazine. In the case of a book, a plurality of pages may be secured together by passing thread through the pages by a needle or other penetrating member as known in the art.

FIG. 2 exemplifies a publication 10 that includes one composite work 14. It will be appreciated that a plurality of pages of publication 10 may comprise composite works. In an alternate embodiment, it will be appreciated that every page of publication 10 may be a composite work 14. It will also be appreciated that alternately or in addition, one or more of the pages may be a non-cellulose substrate that is directly bound into the publication.

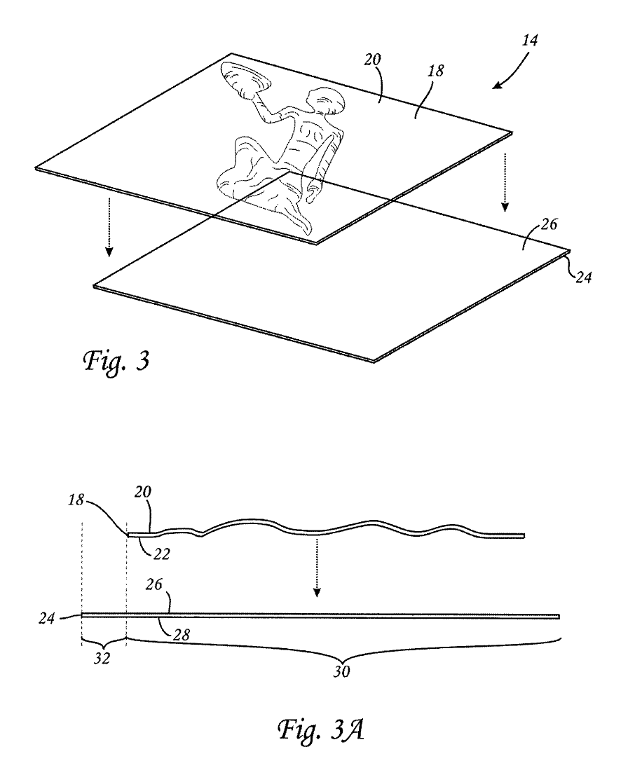

In order to avoid an elongate member passing through the non-cellulose substrate, a composite work 14 may be utilized. As shown in FIGS. 3 and 3A, composite work 14 comprises an non-cellulose image substrate 18, which has an image bearing surface 20 and a rear surface 22, and a mounting substrate (preferably a cellulose substrate) 24, which has a mounting surface 26 and a viewable surface 28.

Mounting substrate 24 may be any material suitable for receiving image substrate 18. If composite work 14 is for use in a publication as exemplified in FIGS. 1, 2, 6 and 6A, then mounting substrate 24 may be any substrate suitable for inclusion as a page in publication 10. Preferably, mounting substrate 24 is cellulose based and, more preferably, is paper or cardboard and, most preferably, paper. It will be appreciated that mounting substrate 24 may be 8 to 100 pound weight paper or a paper mache.

Mounting substrate 24 is preferably planar (i.e., the substrate extends in the X, Y planes) as shown in FIGS. 3 and 3A and has a rear surface 28 which may have text or other material printed thereon in known fashion. Mounting surface 26 is secured to image substrate 18 by any means known in the art. For example, rear surface 22 of substrate 18 may be secured to mounting surface 26 such as by means of an adhesive, such as 3M Fastbond™ or a hot melt glue such as HB Fuller 1138™. In an alternate embodiment, it will be appreciated that rear surface 22 may be removably affixed to mounting surface 26 such as by means of a releasable adhesive, such as guar gum based adhesive. Such an embodiment is particularly preferred if substrate 18 contains a coupon, such as those that are redeemably for a product, or entitles the bearer to a discounted price for a product.

In operation, each of image substrate 18 and mounting substrate 24 are preferably individually prepared. For example, a three dimensional image may be formed in image substrate 18 and text may be printed on viewable surface 28 of mounting substrate 24. The substrates may then be associated together to form composite work 14 and composite work 14 may then be incorporated into publication 10. Alternately, it will be appreciated that image substrate may be secured to mounting substrate 24 after mounting substrate has been secured in publication 10.

It will be appreciated that mounting substrate 24 has first and second portions 30, 32. First portion 30 is used to secure image substrate 18 to mounting substrate 24. Second portion 32 is used to secure mounting substrate 24 to publication 10. It will be appreciated that mounting substrate 24 may comprise a further page of publication 10. Accordingly, mounting substrate 24 may be sized so as to comprise two pages of publication 10, i.e., it may extend an equal distance on both sides of the binding of publication 10.

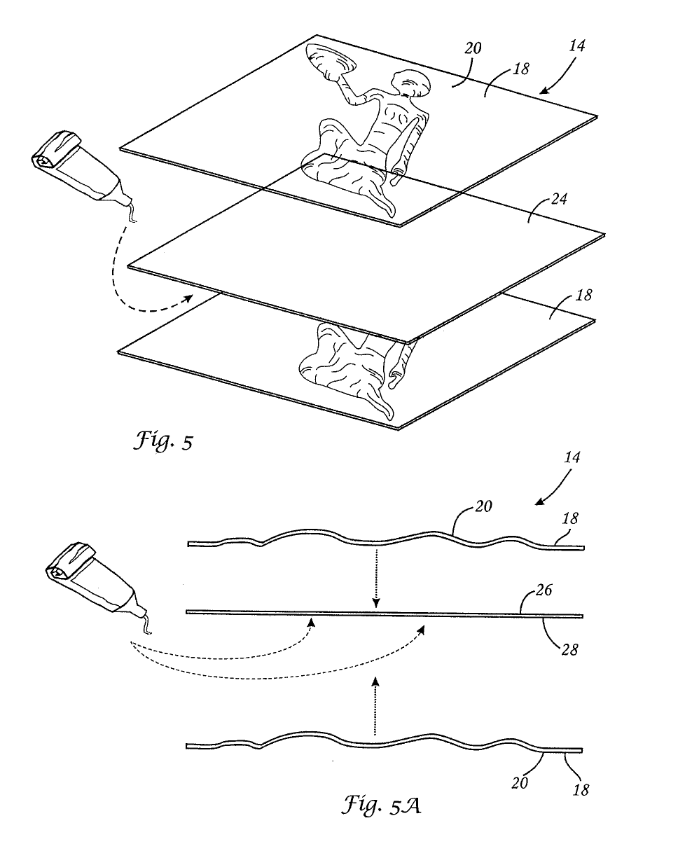

In an alternate embodiment, as exemplified in FIGS. 5 and 5A an image substrate 18 may be affixed to each of the opposed surfaces 26, 28 of mounting substrate 24. Thus composite work 14 may have two image bearing surfaces 20 that are essentially mounted back to back so as to form consecutive pages in publication 10.

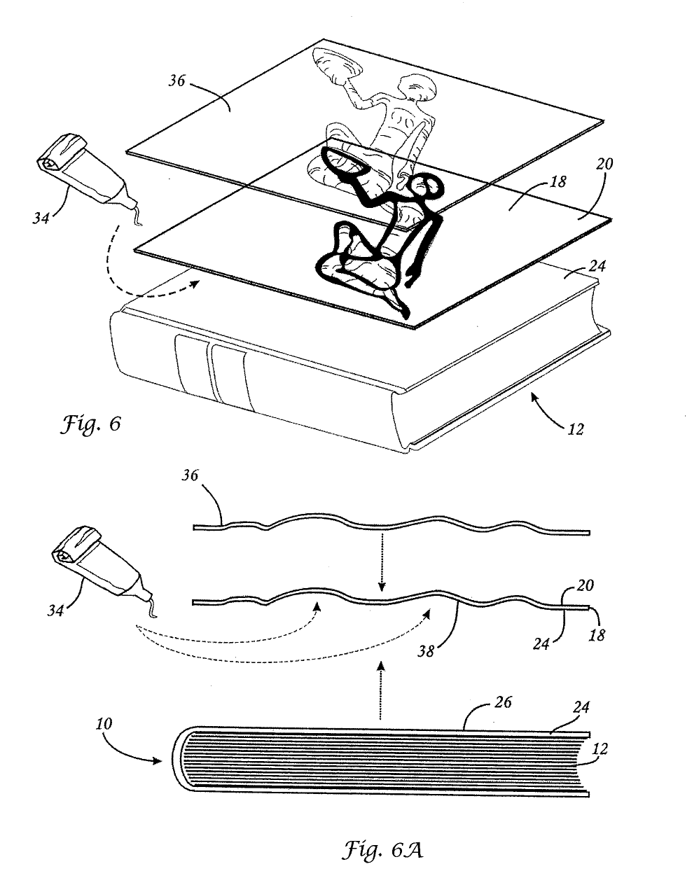

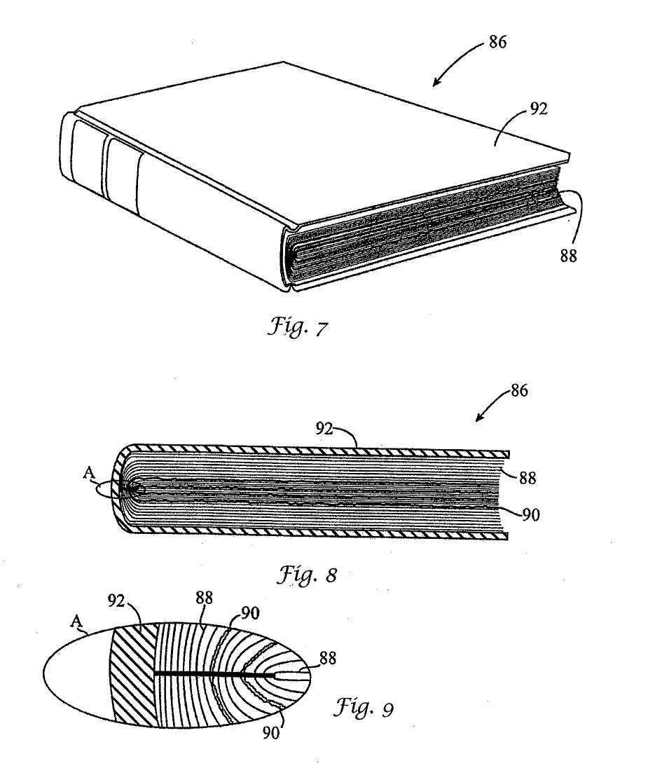

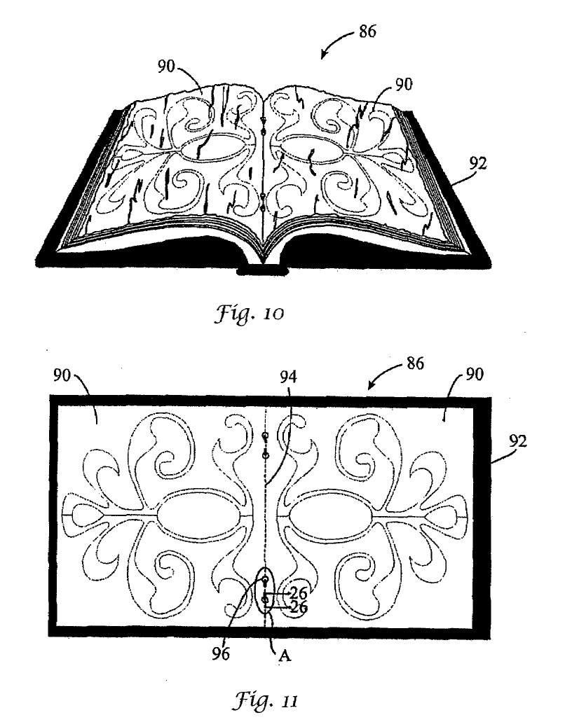

In one embodiment, composite work 14 comprises one or more pages interior of the publication 10 (i.e. between the cover of publication 10). In the alternate embodiment shown in FIGS. 6 and 6A, image substrate 18 provides part or all of the cover of publication 10. As shown therein, image substrate 18 is secured to the cover of a book (i.e. mounting substrate 24), by means of an adhesive 34.

As shown in FIGS. 6 and 6A, optional cover sheet 36 may also be utilized. As image substrate 18 will be provided on an exterior surface, cover sheet 36 may be provided to enhance the durability of image substrate 18. For example, cover sheet 36 may be a thin plastic sheet (i.e. it may have the same thickness as image substrate 18 or it may be thinner) and be secured over image substrate 18 by any means known in the art. As shown in FIGS. 6 and 6A, cover sheet 36 has the same profile or topography formed therein as is formed in image substrate 18. It will be appreciated that if image substrate 18 has a relatively low profile, or if sheet 36 is sufficiently thin and/or elastic, then cover sheet 36 need not be subjected to any pre-treatment steps to provide a three-dimensional image therein but may merely be applied over image bearing surface 20 and conform to the topography of image bearing surface 20 as it is applied.

Due to the forming process, depressions 38 are formed in rear surface 22 of image substrate 18. These depressions form the negative image of the topography formed in image bearing surface 20. In order to enhance the durability of image substrate 18, depressions 38 may be filled, such as by filling depressions 38 with plaster, silicone, epoxy, or other, preferably non shrinking, filler materials. Accordingly, essentially no hollow spaces may be provided between rear surface 22 of image substrate 18 in the cover of book 10. It will be appreciated that in a particularly preferred embodiment, depressions 38 may be filled and cover sheet 36 may be provided. It will be appreciated that these options may be used singularly or in combination with any embodiment set out herein and with any embodiment.

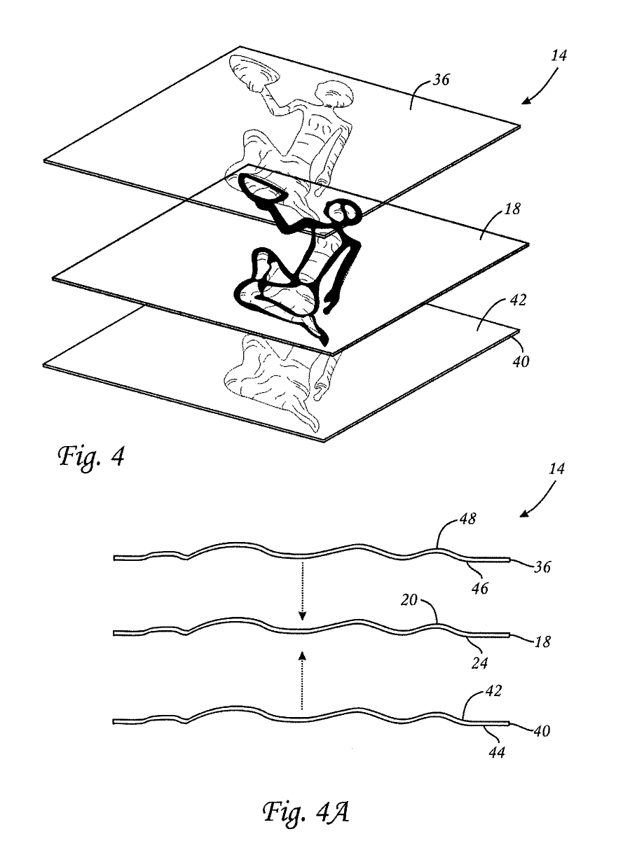

A further alternate embodiment is shown in FIGS. 4 and 4A. In FIGS. 4 and 4A, mounting substrate 18 is provided with both a cover sheet 36 having a mounting surface 46, for being secured to image bearing surface 20 of image substrate 18, and a top surface 48 and with a bottom sheet 40 having a mounting surface 42, for being secured to rear surface 22 of image substrate 18, and a rear surface 44. Bottom sheet 40 may be secured or releasably secured to mounting sheet 18 by the same means used for cover sheet 36 or by a different means. As shown in FIG. 4A, bottom sheet 40 has the same image formed in it as image substrate 18 and as cover sheet 36. Accordingly, mounting surface 42 and rear surface 22 of image substrate 18 are in intimate contact. Preferably, each of cover sheet 36 and bottom sheet 40 form a material that can provide additional dimensional stability to image substrate 18. Accordingly, the composite work 14 shown in FIGS. 4 and 4A may be used in any application disclosed herein and, accordingly, may be secured to mounting substrate 24.

In an alternate embodiment, the substrate itself is directly bound in the publication and a staple or thread or the like is used and passes through the substrate, substrate 90 is preferably configured so as to enable the elongate member to pass therethrough while reducing the likelihood of the substrate tearing or fracturing. Accordingly, the substrate may be provided with holes or openings 96 through which an elongate member, such as staple 98, may extend (see FIGS. 11-13). Such openings are preferably configured so that there is not an angle over 5°. It would be appreciated that holes 96 need not be circular. Accordingly, while holes 96 may be circular or oval, they may merely be radiused so as to have a continuous perimeter.

By providing holes that are preformed in the substrate, the substrate need not be pierced during the binding operation. Instead, during the binding operation, substrate 90 may merely be positioned so that holes 96 are aligned with the staple or elongate member that is to extend therethrough. It will be appreciated that holes 96 may be provided in substrate 90 when the rigidity of substrate 90 has been temporarily reduced, such as by heating or chemical treatment with, e.g. methyl ethyl ketone. It will also be appreciated that holes 96 may be formed during the binding process.

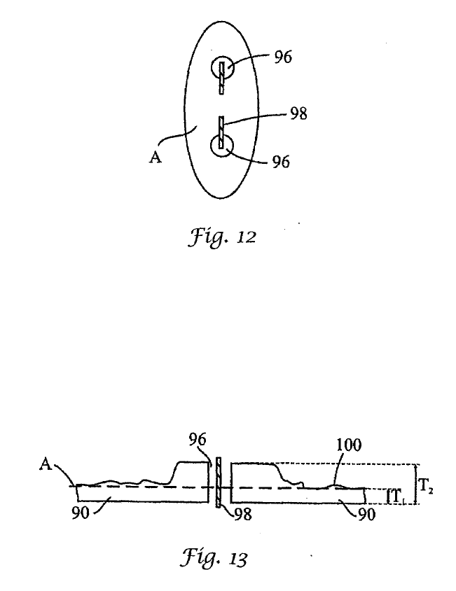

Alternately, or in addition, substrate 90 may have an increased thickness in the vicinity of hole 96. For example, as shown in FIG. 12, substrate 90 generally extends along plane A. It will be appreciated that the actual thickness may vary if substrate 90 is provided with a three-dimensional image or topography 100 formed therein. Distal to hole 96, substrate 90 has a thickness of about T1. However, adjacent hole 96, the thickness of substrate 90 has been increased to T2. Accordingly, the image-bearing surface of substrate 90 extends out of plane A adjacent the perimeter of opening or hole 96. It will be appreciated that only one, or each, opposed surface of substrate 90 may be configured to extend out of plane A.

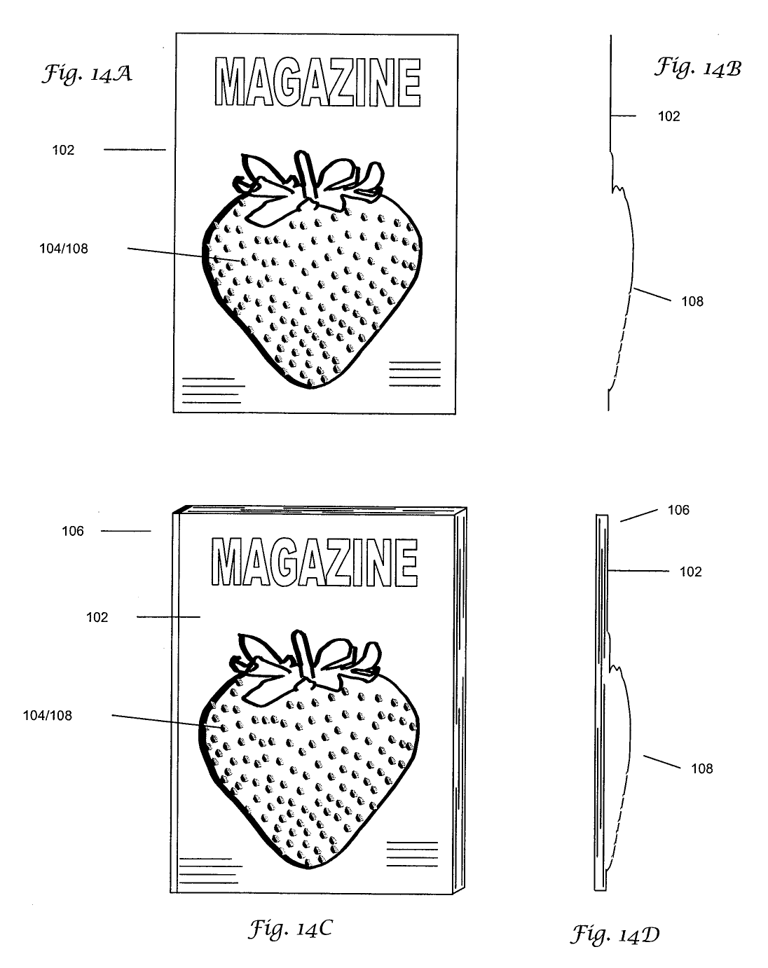

Another exemplary embodiment of a publication page that is made of a substrate and is integrally incorporated into a publication is explained below with reference to FIGS. 14A-14D.

The non-cellulose substrate used to make the page 102 to be incorporated into a publication 106 may be made by any method known in the art or described herein, and is preferably a thermoformable plastic or metal.

Generally, at least one side of the page 102 made from a substrate is provided with a substantially two-dimensional image 104. As an example, referring to FIG. 14A a two-dimensional image 104 of a berry is provided on a publication cover page 102 made from a substrate.

As noted above, the image 104 may be provided on the page 102 utilizing any method known in the art, including one or more of offset lithography, silk screening, spray coating, ink jet printing or dye simulation printing. However, the page 102 may comprise any image, text, design, and/or other material typically included on a publication page, such as an advertisement or cover page.

The page 102 can be formed or treated to provide a three-dimensional relief or topographical texture 108 corresponding to the image 104 provided thereon, such that at least one specific feature of the image 104 provided on the page 102 varies in a third dimension orthogonal to the two dimensions of the image 104. That is, the topographical texture 108 provided in the page 102 aligns with the two-dimensional image 104 thereon, such that the texture 108 corresponds to at least one feature of the two-dimensional image 104.

For example, referring to FIG. 14A, there is shown a plan view of the page 102 with a three-dimensional topographical texture 108 formed over the two-dimensional image 104 of the berry provided thereon. This is further shown in FIG. 14B, which illustrates a cross sectional view of the page 102 after the page 102 (made from the substrate) is provided with a three-dimensional topographical texture 108 corresponding to the two dimensional image of the berry 104 thereon. An example of a topographical texture is a three-dimensional shape of the berry. Moreover, additional three-dimensional textured details of the berry may also be provided in the substrate. For example the seeds of the berry on its skin (not shown) may be given a topographical texture to distinguish them from surrounding portions of the berry. Thus, the three dimensional topographical texture 108 may have a plurality of three-dimensional depths so as to simulate the real life texture and relief of the object portrayed in the image 104. Further, preferably, the scaling of the texture varies. For example, if the berry contains seeds, then the seeds may have a proportionately greater variation in the Z dimension then the berry itself. Accordingly, the ratio of the thickness of the seeds in the textured image compared to the actual thickness of a seed, may be greater than the thickness of the berry in the textured image compared to the actual thickness of a berry.

Accordingly, the design may be an actual object, such as a berry. The scale factor that is used for the length and width of the two dimensional reproduction of the object (i.e. the ratio of the length and width of an actual berry compared to the length and width of the image of the berry on the substrate) is preferably scaled at a different scale to the depth of the object (i.e. the ratio of the depth of an actual berry compared to the depth of the image of the berry on the substrate). For example, the depth of the textured reproduction in the Z dimension may be scaled at a substantially reduced scale compared to the scaling utilized for the X and Y dimensions. In such a case, the substrate has a bold appearance and will attract the attention of the person but will be able to be contained on a substrate.

As another example, the page 102 may be treated or formed such that only certain objects or aspects of the substantially two-dimensional image 104 have a corresponding three-dimensional topographical texture 108 provided therein, while the remaining portions of the image remain substantially two-dimensional. For example, the image provided on the substrate may be a human wearing a bathing suit and only the portion of the image depicting a bathing suit may have a corresponding three-dimensional topographical texture provided in the substrate (not shown). For example, the texture and natural shape of the bathing suit, such as the ripples in the bathing suit fabric and the curves of the underlying human body may be formed into the page as the topographical texture while the rest of the page (and by extension the image thereon) remains substantially two-dimensional. This may be desirable to enhance or accentuate certain aspects of the image, such as for example if the image on the page relates to an advertisement for bathing suits.

Moreover, topographical texture 108 formed on the page 102 is not limited to corresponding to three-dimensional features of a two-dimensional image 102 and may correspond to any image, text, or design typically provided in a publication page, advertisement or the like. However, for simplicity of explanation the topographical texture 108 is described in relation to three-dimensional features of a two-dimensional image 104.

The page 102 may be directly and non-replacably incorporated into a publication 106 as one or mores pages (including the cover of the publication) such that the page 102 unitarily and integrally forms a page in the publication 106, along with the other pages in the publication 106. That is, the page 102 with the image 104 thereon is a single continuous substrate and topographical texture 108 formed over the image 104 makes up a page of the publication 106, such that it is not necessary to mount the page 102 onto an additional page in the publication 106 or the optional mounting substrate disclosed herein or other form of mounting substrate incorporated into the publication 106, such as plastic, cardboard or other suitable cellulose based substrate. Instead the page 102 may be incorporated directly into the publication 106 as a cover or interior page of the publication 106. The methods utilized to directly and non-replacably incorporate the page 102 made from a substrate into a publication 106 may be any suitable binding method known in the art and/or described above in relation to publication 10 and/or publication 86.

For example, FIG. 14C illustrates a cover page 102 made from a substrate with a topographical texture 108 formed over a two-dimensional image 104 directly incorporated into a publication 106, and more particularly as a cover for the publication 106 such that the page 102 is not mounted onto an underlying cover page of the publication 106 (not exemplified). This is further shown in FIG. 14D, which illustrates a cross sectional view of the publication 106 with the page 102 (and the formed topographical texture 108 therein exaggerated for demonstration) incorporated into the publication 106 as the cover page, with no exterior separate cover sheet.

In some embodiments, an optional cover sheet may be secured to the page 102 that is directly incorporated into the publication 106 in order to enhance the durability of page 102, such as cover sheet 36 described above in relation to FIGS. 6 and 6A. As above, the cover sheet may be a thin plastic sheet and may be secured over image substrate using means known in the art. Moreover, cover sheet may have the same profile or topography formed therein as page 102.

Alternatively, the page 102 with the image 104 provided thereon and topographical texture 108 formed corresponding to part or all of the image 104 may have a backing layer secured to the reverse side of the substrate (i.e. the side that does not contain the textured image or the non-image bearing surface) (not shown). The backing layer may be constructed using a variety of material(s), such as plastic, metal, cardboard, paper mache or other suitable cellulose based substrate.

The page 102 and backing layer may make up a composite work 14, where the backing layer is the mounting substrate 24 and page 102 is the image substrate 18, as described above in relation to the publication 10 and FIGS. 1 to 6A. Moreover, the backing layer secured to the reverse side of the page 102 may be an additional page of the publication 106.

It will be appreciated that the page 102 may be secured to the backing layer using any means known in the art and/or described herein, such as by means of an adhesive, such as 3M Fastbond™ or a hot melt glue such as HB Fuller 1138™. Alternatively, the backing layer may be removably affixed to the page 102 such as by means of a releasable adhesive, such as a guar gum based adhesive.

As described above, the side of the backing layer that is not directly secured to the page 102 may contain text, images or other design that is typically included in a publication. A backing layer may be desirable as the rear surface of the formed page 102 may be a negative version of the topographical texture 108 provided therein, which may result in an unusable page in the publication as it may be less desirable to print text or an image on the negative topographical texture side of the page 102 as the text or image may be difficult to read. Accordingly, a backing layer with an image or text printed on the side that is not secured to the page provides an additional page in the publication 106, such that both sides of the page 102 in the publication 106 are utilized.

Although the substrate is generally described herein as being flat, i.e. extending only in the X and Y dimensions, it will be appreciated that the substrate may be curved or of an alternate configuration. In such embodiments, the three-dimensional topographical texture formed therein may then vary orthogonal to a line tangent to the substrate at a given position, as will be understood by those skilled in the art.

It will be appreciated that various modifications and additions may be made to the embodiments disclosed herein and each are in the scope of the following claims. It will be appreciated that any of the embodiments set out herein, or preferences for any embodiments, may be used in conjunction with any other embodiment or optional preferences.

1. A method of producing a publication comprising
a) providing a plurality of pages;
b) providing a substantially two dimensional image on at least one side of a page of the plurality of pages to provide at least one image page wherein the at least one image page is made of metal or plastic;
c) providing a topographical texture corresponding to at least one feature of the two dimensional image, such that the at least one feature of the two dimensional image varies in a third dimension orthogonal to the two dimensions of the two dimensional image; and,
d) attaching the plurality of pages together to form the publication.

2. The method as defined in claim 1 wherein the at least one page is made of a deformable material, and step (c) comprises molding the deformable material to provide the topographical texture.

3. The method as defined in claim 1 wherein the at least one image page is made of plastic.

4. The method as defined in claim 3 wherein the at least one image page is molded to provide the topographical texture.

5. The method as defined in claim 1 further comprising attaching the at least one image page as the cover of the publication.

6. The method as defined in claim 5 wherein the at least one image page comprises an image side bearing the two dimensional image and a reverse side and the method further comprising providing a backing layer on the reverse side.

7. The method as defined in claim 6 wherein the backing layer is formed by adhering an additional page to the reverse side.

8. The method as defined in claim 1 wherein the at least one image page comprises an image side bearing the two dimensional image and a reverse side and the method further comprising providing a backing layer on the reverse side.

9. The method as defined in claim 8 wherein the backing layer is formed by adhering an additional page to the reverse side.

10. A publication comprising a plurality of pages, including at least one image page, non-replacably secured together, the at least one image page being made of at least one of metal and plastic and having a textured image comprising:
a substantially two dimensional image on at least one side of the image page; and,
a texture aligned with the two dimensional image wherein the texture corresponds to at least one feature of the two dimensional image.

11. The publication as defined in claim 10 wherein the at least one image page is a molded page.

12. The publication as defined in claim 10 wherein the image page is the cover of the publication.

13. The publication as defined in claim 12 wherein the image page comprises an image side bearing the two dimensional image and a reverse side and the reverse side has a backing layer affixed thereto.

14. The publication as defined in claim 13 wherein the backing layer comprises an additional page affixed to the reverse side.

15. The publication as defined in claim 14 wherein the additional page has a print side and a reverse side and the reverse side of the additional page is affixed to the reverse side of the image page and the print side has at least one of an image and a word provided thereon.

16. The publication as defined in claim 10 wherein the image page comprises an image side bearing the two dimensional image and a reverse side and the reverse side has a backing layer affixed thereto.

17. The publication as defined in claim 16 wherein the backing layer comprises an additional page affixed to the reverse side.

18. The publication as defined in claim 17 wherein the additional page has a print side and a reverse side and the reverse side of the additional page is affixed to the reverse side of the image page and the print side has at least one of an image and a word provided thereon.
